(19) United States
(12) Patent Application Publication
(10) Pub. No.: US 2005/0281457 A1
(43) Pub. Date: Dec. 22, 2005

(54) System and method for elimination of irrelevant and redundant features to improve cad performance

(76) Inventor: Murat Dundar, Malvern, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/140,290

(22) Filed: May 27, 2005

Related U.S. Application Data
(60) Provisional application No. 60/576,115, filed on Jun. 2, 2004.

(51) Int. Cl. G06K 9/62

(52) U.S. Cl. 382/159

(57) ABSTRACT

A computer-implemented method for processing an image includes identifying a plurality of candidates for an object of interest in the image, extracting a feature set for each candidate, determining a reduced feature set by removing a least one redundant feature from the feature set to maximize a Rayleigh quotient, determining at least one candidate of the plurality of candidates as a positive candidate based on the reduced feature set, and displaying the positive candidate for analysis of the object.

This application claims priority to U.S. Provisional Application Ser. No. 60/576,115, filed on Jun. 2, 2004, which is herein incorporated by reference in its entirety.

### BACKGROUND OF THE INVENTION

1. Technical Field

The present invention relates to image processing, and more particularly to system and method for feature selection in an object detection system.

2. Discussion of Related Art

Features of medical images are typically identified by several imaging technicians working independently. As a result, technicians often identify the same or similar features. These features may be redundant or irrelevant, which may in turn impact classifier performance.

Therefore, a need exists for a system and method of eliminating redundant and irrelevant features from a feature set.

### SUMMARY OF THE INVENTION

According to an embodiment of the present disclosure, a computer-implemented method for processing an image includes identifying a plurality of candidates for an object of interest in the image, extracting a feature set for each candidate, determining a reduced feature set by removing a least one redundant feature from the feature set to maximize a Rayleigh quotient, determining at least one candidate of the plurality of candidates as a positive candidate based on the reduced feature set, and displaying the positive candidate for analysis of the object.

Determining the reduced feature set comprises initializing a discriminant vector and a regularization parameter, and determining, iteratively, the reduced feature set.

Determining, iteratively, the reduced feature set includes determining the reduced feature set according to the discriminant vector, wherein features of the feature set with an element of the discriminant vector greater than a threshold are selected as the reduced feature set, determining a class scatter matrix and mean in a reduced dimensional space defined by the reduced feature set, determining a transformation vector, updating the class scatter matrix and means according to the transformation vector, and determining the discriminant vector. The method comprises comparing, at each iteration, each element of the discriminant vector to a threshold, and stopping the iterative determination of the reduced feature set upon determining that all elements are greater than the threshold. The threshold is a user defined variable for controlling a degree to which features are eliminated.

The transformation vector and the discriminant vector can be determined as:

$$\begin{matrix}{min}_{α , a ∈ {R}^{d}} \\ s . t .\end{matrix} \begin{matrix}{α}^{T} ( {S}_{w} * ( {aa}^{T} ) ) α \\ {α}^{T} ( ( {m}_{+} - {m}_{-} ) * a = b \\ {α}^{T} {e}_{l} \leq γ , α \geq 0\end{matrix} .$$

According to an embodiment of the present disclosure, a program storage device is provided readable by machine, tangibly embodying a program of instructions executable by the machine to perform method steps for processing an image. The method includes identifying a plurality of candidates for an object of interest in the image, extracting a feature set for each candidate, determining a reduced feature set by removing a least one redundant feature from the feature set to maximize a Rayleigh quotient, determining at least one candidate of the plurality of candidates as a positive candidate based on the reduced feature set, and displaying the positive candidate for analysis of the object.

According to an embodiment of the present disclosure, a computer-implemented detection system comprises an object detection module determining a candidate object and a feature set for the candidate object, and a feature selection module coupled to the object detection module, wherein the feature selection module receives the feature set and generates a reduced feature set having a desirable value of a Rayleigh quotient, wherein the object detection modules implements the reduced feature set for detecting an object in an image.

The feature selection module further includes an initialization module setting an initial value of a discriminant vector and a regularization parameter, a reduction module determining the reduced feature set according to the discriminant vector, wherein features of the feature set with an element of the discriminant vector greater than a threshold are selected as the reduced feature set, and a discriminant module determining a class scatter matrix and mean in a reduced dimensional space defined by the reduced feature set. The feature selection module further includes a sparsity module determining a transformation vector, and an update module updating the class scatter matrix and means according to the transformation vector, wherein the sparsity module determines the discriminant vector given the updated class scatter matrix and means.

### BRIEF DESCRIPTION OF THE DRAWINGS

Preferred embodiments of the present invention will be described below in more detail, with reference to the accompanying drawings:

FIG. 1 is a system according to an embodiment of the present disclosure;

FIG. 2 is a flow chart of a method according to an embodiment of the present disclosure;

FIG. 3 is a graph of testing error according to an embodiment of the present disclosure;

FIG. 4A is a graph of receiver operating characteristics (ROC) curves for training results according to an embodiment of the present disclosure;

FIG. 4B is a graph of receiver operating characteristics (ROC) curves for training results according to an embodiment of the present disclosure;

FIG. 5 is a flow chart of a method according to an embodiment of the present disclosure; and

FIG. 6 is a diagram of an object detection system according to an embodiment of the present disclosure.

### DETAILED DESCRIPTION OF PREFERRED EMBODIMENTS

According to an embodiment of the present disclosure, irrelevant and redundant features are automatically eliminated from a feature set extracted from images, such as CT or MRI images.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

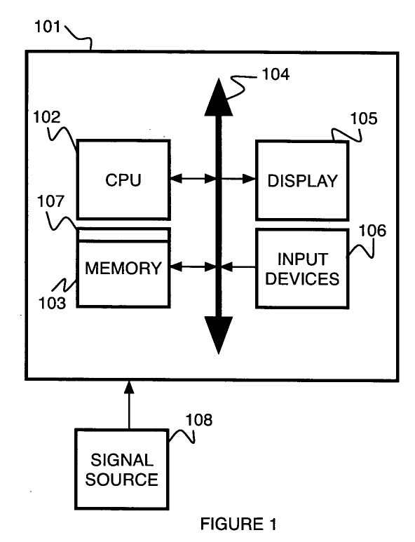

Referring to FIG. 1, according to an embodiment of the present disclosure, a computer system 101 for implementing a image processing method can comprise, inter alia, a central processing unit (CPU) 102, a memory 103 and an input/output (I/O) interface 104. The computer system 101 is generally coupled through the I/O interface 104 to a display 105 and various input devices 106 such as a mouse and keyboard. The support circuits can include circuits such as cache, power supplies, clock circuits, and a communications bus. The memory 103 can include random access memory (RAM), read only memory (ROM), disk drive, tape drive, etc., or a combination thereof. The present invention can be implemented as a routine 107 that is stored in memory 103 and executed by the CPU 102 to process the signal from the signal source 108. As such, the computer system 101 is a general purpose computer system that becomes a specific purpose computer system when executing the routine 107 of the present invention.

The computer platform 101 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

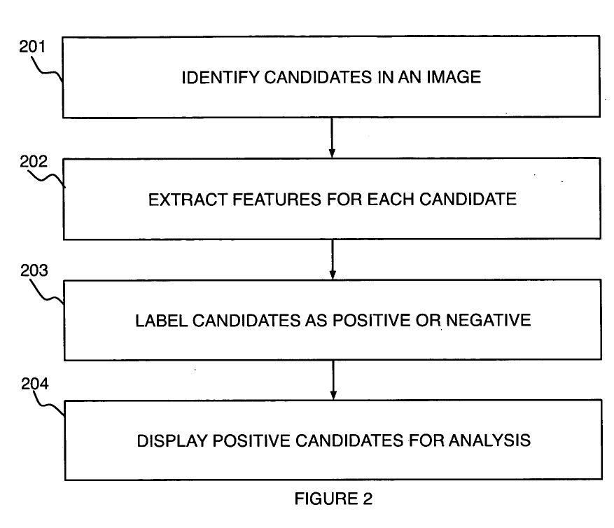

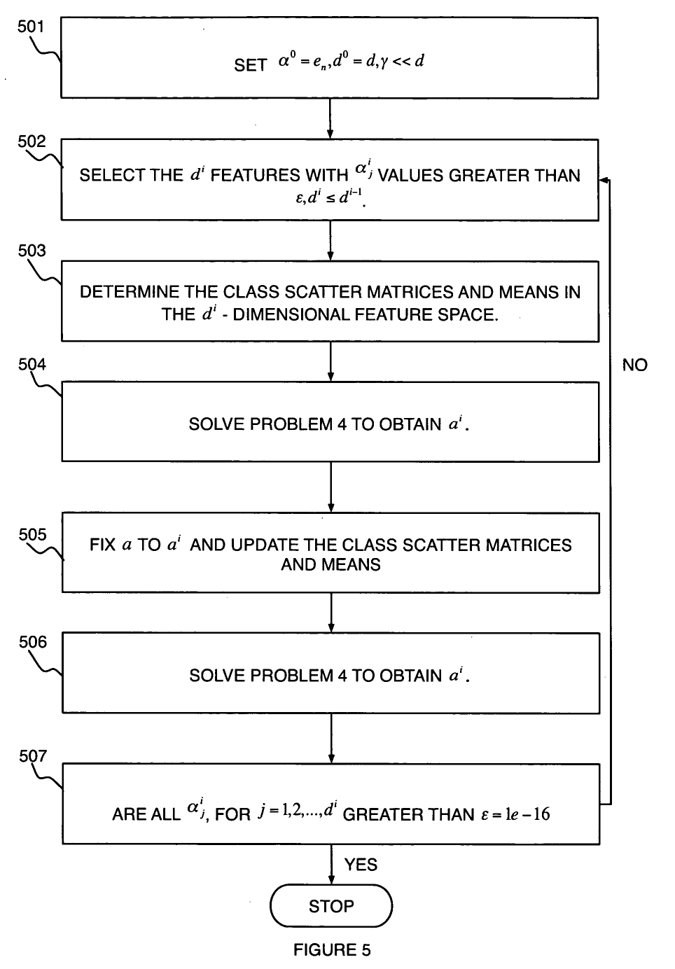

Referring to FIG. 2, a Computer-Aided Detection (CAD) system automatically identifies candidates for an object of interest in an image 201 given known characteristics such as the shape of an abnormality, e.g., a polyp, extract features for each candidate 202, wherein a determined feature set is reduced (e.g., see FIG. 5), labels candidates as positive or negative 203, and displays positive candidates to a radiologist for diagnosis 204. The labeling or classification is performed by a classifier that has been trained off-line from a training dataset and then frozen for use in the CAD system. The training dataset is a database of images where candidates have been labeled by an expert. The ability to generalize is important to the CAD system and thus the classifier. The classifier needs to correctly labels new datasets. Because a large number of different classifiers can be built from the training data using classification methods, each with adjustable parameters, the choice of the classifier is important.

Classification performance is determined by a classification methods used and an inherent class information available in the features provided. The classification methods determine the best achievable separation between classes by exploiting the potential information available within the feature set.

In real-world settings the number of features available can be more than needed. It is expected that a large number of features would provide more discriminating power. With a limited number of training examples in a high dimensional feature space two classes can be separated in many ways. However, for generalization ability, few separations will generalize well on the new datasets. Thus, feature selection is important.

According to an embodiment of the present disclosure, an automatic feature selection method is built into Fisher's Linear Discriminant (FLD). The method identifies a feature subset by iteratively maximizing a ratio between and within class scatter matrices with respect to the discriminant coefficients and feature weights, respectively (see FIG. 5).

The FLD arises in a special case when classes have a common covariance matrix. FLD is a classification method that projects the high dimensional data onto a line for a binary classification problem and performs classification in this one dimensional space. This projection is chosen such that the ratio of between and within class scatter matrices or the Rayleigh quotient is maximized.

Let Xᵢ ε R^{d×l} be a matrix containing the l training data points on d-dimensional space and lᵢ the number of labeled samples for class ωᵢ, i ε {±}. FLD is the projection α, which maximizes,

$$J ( α ) = \frac{{α}^{T} {S}_{B} α}{{α}^{T} {S}_{W} α} \\ where \\ {S}_{B} = ( {m}_{+} - {m}_{-} ) {( {m}_{+} - {m}_{-} )}^{T} \\ {S}_{W} = {\sum }_{i ∈ \{ \pm \}} \frac{1}{{l}_{i}} ( {X}_{i} - {m}_{i} {e}_{{l}_{i}}^{T} ) {( {X}_{i} - {m}_{i} {e}_{{l}_{i}}^{T} )}^{T} \qquad ( 1 )$$

are the between and within class scatter matrices respectively and

$${m}_{i} = \frac{1}{{l}_{i}} {X}_{i} {e}_{{l}_{i}}$$

is the mean of class ωᵢ and eₗᵢ is an lᵢ dimensional vector of ones.

Transforming the above problem into a convex quadratic programming problem provides algorithmic advantages. For example, notice that if α is a solution to Eq. (1), then so is any scalar multiple of it. Therefore, to avoid multiplicity of solutions, a constraint α^{T}S_{B}α=b² is imposed, which is equivalent to α^{T}(m₊−m₋)=b where b is some arbitrary positive scalar. Then the optimization problem of Eq. (1) becomes,

$$Problem 1 : \qquad \begin{matrix}{min}_{α ∈ {R}^{d}} \\ s . t .\end{matrix} \begin{matrix} {α}^{T} {S}_{W} α \\ {α}^{T} ( {m}_{+} - {m}_{-} ) = b\end{matrix}$$

For binary classification problems the solution of this problem is

$${α}^{*} = \frac{b {S}_{W}^{- 1} ( {m}_{+} - {m}_{-} )}{{( {m}_{+} - {m}_{-} )}^{T} {S}_{W}^{- 1} ( {m}_{+} - {m}_{-} )} .$$

Note that each element of the discriminant vector is a weighted sum of the difference between class mean vectors where the weighting coefficients are rows of

$$\frac{b {S}_{W}^{- 1}}{{( {m}_{+} - {m}_{-} )}^{T} {S}_{W}^{- 1} ( {m}_{+} - {m}_{-} )} .$$

According to this expansion since S_{W}⁻¹ is positive definite unless the difference of the class means along a given feature is zero all features contributes to the final discriminant.

If a given feature in the training set is redundant, its contribution to the final discriminant would be artificial and not desirable. As a linear classifier FLD is well suited to handle features of this sort provided that they do not dominate the feature set, that is, the ratio of redundant to relevant features is not significant. Although the contribution of a single redundant feature to the final discriminant would be negligible when several of these features are available at the same time, the overall impact could be quite significant leading to poor prediction accuracy. Apart from this impact, in the context of FLD these undesirable features also pose numerical constraints on the computation of S_{W}⁻¹ especially when the number of training samples is limited. Indeed, when the number of features, d is higher than the number of training samples, l, S_{W} becomes ill-conditioned and its inverse does not exist. Hence eliminating the irrelevant and redundant features may provide a two-fold boost on the performance.

According to an embodiment of the present disclosure, a sparse formulation of FLD incorporating a regularization constraint on the FLD. A system and method eliminate those features determined to have limited impact on the objective function.

Sparse Fisher Discriminant Analysis: Blindly fitting classifiers without appropriate regularization conditions yields over-fitted models. Methods for controlling model complexity are needed in modern data analysis. In particular, when the number of features available is large, an appropriate regularization can dramatically reduce the dimensionality and produces better generalization performance that is supported by learning theory. For linear models of the form α^{T}x as considered here, well-established regularization conditions include the 2-norm penalty and 1-norm penalty on the weight vector α. A regularized model fitting problem can be written as:

$$\hat{f} = {min}_{f} ( error ( f ) + λ P ( f ) ) .$$

(2) where λ is called the regularization parameter.

According to an embodiment of the present disclosure, a 1-norm penalty P(f)=Σ|αᵢ| has been implemented in a sparse FLD formulation, which generates sparser feature subsets than 2-norm penalty. The regularized model fitting formulation of Eq. (2) has an equivalent formulation as

$$\hat{f} = {min}_{f} ( error ( f ) ,$$

subjectto: P(f)≦γ). (3) where the parameter γ plays a similar role to the regularization parameter λ in Eq. (2) to trade off between the training error and the penalty term.

If α is required to be non-negative, the 1-norm of can be determined as α^{T}eₗ. Optimization Problem 2 may be obtained.

With new constraints Problem 1 can be updated as follows,

$$Problem 2 \text{:} \qquad \begin{matrix}{min}_{α , a ∈ {R}^{d}} \\ s . t .\end{matrix} \begin{matrix}{α}^{T} {S}_{w} α \\ {α}^{T} ( {m}_{+} - {m}_{-} ) = b \\ {α}^{T} {e}_{l} \leq γ , α \geq 0\end{matrix} .$$

The feasible set associated with Problem 1 is denoted by Ω₁={α ε R_{d},α^{T}(m₊−m₋)=b} band that associated with Problem 2 by Ω₁={α ε R_{d},α^{T}(m₊−m₋)=b,α^{T}eₗ≦γ,α≧0}, and observe that Ω₂ ⊂ Ω₁.

$${δ}_{max} = {max}_{i} \frac{b}{{( {m}_{+} - {m}_{-} )}_{i}} and {δ}_{min} = {min}_{i} \frac{b}{{( {m}_{+} - {m}_{-} )}_{i}}$$

are defined where i={1, . . . , d}. The set Ω₂ is empty whenever δₘₐₓ<0 or δₘᵢₙ>γ. In addition to the feasibility constraints γ<δₘₐₓ should hold to achieve a sparse solution. According to an embodiment of the present disclosure, a linear transformation will ensure δₘₐₓ>0 and standardize the sparsity constraint.

For simplicity and without loss of generality S_{W} is assumed to be a diagonal matrix with elements λᵢ,i=1, . . . , d where λᵢ are the eigenvalues of S_{W}. Under this scenario a solution to Problem 1 is

$${α}^{*} = {\overline{b} [ \frac{{( {m}_{+} - {m}_{-} )}_{1}}{{λ}_{1}} , … , \frac{{( {m}_{+} - {m}_{-} )}_{d}}{{λ}_{d}} ]}^{T}$$

$$where$$

$$\overline{b} = \frac{b}{{{\sum }_{i ∈ ( \pm )}}^{\frac{{( {m}_{+} - {m}_{-} )}_{i}^{2}}{{λ}_{1}}}} .$$

A linear transformation is defined as

$$D = diag ( {α}_{1}^{*} , … , {α}_{d}^{*} ) = \overline{b} diag ( \frac{{( {m}_{+} - {m}_{-} )}_{1}}{{λ}_{1}} , … , \frac{{( {m}_{+} - {m}_{-} )}_{d}}{{λ}_{d}} )$$

such that x [symbol] Dx where diag indicates a diagonal matrix. With this transformation, Problem 2 takes the following form
Problem 3:

$$\begin{matrix}{min}_{α ∈ {R}^{d}} & {α}^{T} {DS}_{W} D α \\ s . t . & {α}^{T} D ( {m}_{+} - {m}_{-} ) = b \\ & {α}^{T} {e}_{l} \leq γ , α \geq 0\end{matrix}$$

$${\overline{δ}}_{max} = {max}_{i} \frac{b {λ}_{i}}{{\overline{b} ( {m}_{+} - {m}_{-} )}_{i}^{2}} and {\overline{δ}}_{min} = {min}_{i} \frac{b {λ}_{i}}{{\overline{b} ( {m}_{+} - {m}_{-} )}_{i}^{2}}$$

are defined where i={1, . . . , d}. Note that \overline{δ}ₘᵢₙ and \overline{δ}ₘₐₓ are nonnegative and hence both feasibility constraints are satisfied when δₘᵢₙ>γ. For γ>d the globally optimum solution α* to Problem 3 is α*=[1, . . . , 1]^{T}, i.e., nonsparse solution. For γ<d sparse solutions can be obtained. Unlike Problem 2 where the upper bound on γ depends on mean vectors, here the upper bound is d, i.e., the number of features.

The sparse formulation is a biconvex programming problem.
Problem 4:

$$\begin{matrix}{min}_{α , a ∈ {R}^{d}} & {α}^{T} ( {S}_{W} * ( α {a}^{T} ) ) α \\ s . t . & {α}^{T} ( ( {m}_{+} - {m}_{-} ) * a ) = b \\ & {α}^{T} {e}_{l} \leq γ , α \geq 0\end{matrix}$$

An initialization, α=[1, . . . , 1]^{T}, is performed, and α* is solved for, e.g., a solution to Problem 1. α* is fixed and α* is solved for, e.g., a solution to Problem 3.

The Iterative Feature Selection Method: Referring to FIG. 5, successive feature elimination can be obtained by iteratively solving the above biconvex programming problem.
(501) Set the discriminant vector to all ones, the regularization parameter to d such that γ is much less than d; α⁰=eₙ,d⁰=d,γ<<d
For each iteration i do the following:
(502) Select the dⁱ features with αⱼⁱ values greater than ε,dⁱ≦d^{i-l}, e.g., select the features with the corresponding element of the discriminant vector greater than ε.
(503) Determine the class scatter matrices and means in the dⁱ—dimensional (reduced) feature space.
(504) Solve Problem 4 to obtain aⁱ, the transformation vector.
(505) Using the newly obtained transformation vector, fix a to aⁱ and update the class scatter matrices and means.
(506) Solve Problem 4 to obtain αⁱ, the discriminant.
(507) Stop when all αⱼⁱ, for j=1,2, . . . , dⁱ are greater than ε=1e−16; e.g., stop if none of the elements of the discriminant vector is less than ε.
ε is a threshold for controlling how aggressive feature elimination is performed, ε may be user selected.

Since at each iteration α is truncated the above method is not guaranteed to converge. However, at any iteration i when dⁱ≦γ no sparseness would be achieved and hence all αⱼⁱ would be equal to one. Therefore the algorithm stops when dⁱ<γ, at the latest.

Experimental Results: A Toy Example; this experiment is adapted from Weston et al., Feature Selection for SVMs, Advances in Neural Information Processing Systems, 13 pp. 668-674. Using an artificial data it has been demonstrated that the performance of conventional FLD suffers from the presence of too many irrelevant features whereas the proposed sparse approach produces a better prediction accuracy by successfully handling these irrelevant features.

The probability of y=1 or y=−1 is equal. The first three features x₁,x₂,x₃ are drawn as xᵢ=yN(i,5). Note that only one of these features is relevant for discriminating one class from the other, the other two are redundant. The rest of the features are drawn as xᵢ=N(0,20). Note that these features are noise. The noise features are added to the feature set one by one allowing us to observe the gradual change in the prediction capability of both approaches.

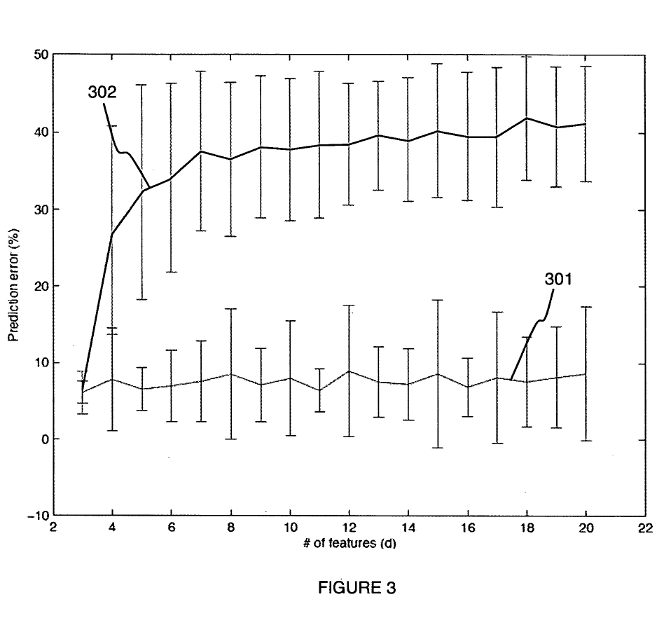

The method is initialized as d=3, e.g., start with the first three features and proceed as follows. Samples are generated for training (e.g., 200) and samples are generated for testing (e.g., 1000). Both approaches are trained and tested. The corresponding prediction errors are recorded. d is increased by one and repeat the above procedure until we reach d=20. For the proposed approach we select the best two features. The error bars in FIG. 3 are obtained by repeating the above process 100 times for each d each time using a different training and testing set.

FIG. 3 illustrates testing error vs. l for artificial data. Full dimensionality and two-dimensional feature subset compared: Curve 301 corresponds to FLD and curve 302 corresponds to a sparse method according to an embodiment of the present disclosure.

Looking at the results, at d=3 with two redundant features the prediction accuracy of the conventional FLD is decent. With the same two redundant features at d=3 the standard deviation in prediction error is smaller under a method according to an embodiment of the present disclosure indicating the elimination of one or both of the redundant features. As d gets larger and noise features are added to the feature set the performance of the conventional FLD deteriorates significantly whereas the average prediction error for the proposed formulation remains around its initial level with some increase in the standard deviation. Also 90% of the time a method according to an embodiment of the present disclosure selects feature two and three. together. These are the two most powerful features in the set.

### EXAMPLE 2

### Colon Cancer

Data Sources and Domain Description; Colorectal cancer is the third-most common cancer in both men and women. It is estimated that in 2004, nearly 147,000 cases of colon and rectal cancer will be diagnosed in the US, and more than 56,730 people would die from colon cancer. While there is wide consensus that screening patients is effective in decreasing advanced disease, only 44% of the eligible population undergoes any colorectal cancer screening. There are many factors for this, Multiple reasons have been identified for non-compliance, key being: patient comfort, bowel preparation and cost. Non-invasive virtual colonoscopy derived from computer tomographic (CT) images of the colon holds great promise as a screening method for colorectal cancer, particularly if CAD tools are developed to facilitate the efficiency of radiologists' efforts in detecting lesions. In over 90% of the cases colon cancer progressed rapidly is from local (polyp adenomas) to advanced stages (colorectal cancer), which has very poor survival rates. However, identifying (and removing) lesions (polyp) when still in a local stage of the disease, has very high survival rates, thus illustrating the critical need for early diagnosis.

The database of high-resolution CT images used in this study were obtained from NYU Medical Center, Cleveland Clinic Foundation, and two EU sites in Vienna and Belgium. The 163 patients were randomly partitioned into two groups: training (n=96) and test (n=67). The test group was sequestered and only used to evaluate the performance of the final system.

Training Data Patient and Polyp Info: There were 96 patients with 187 volumes. A total of 76 polyps were identified in this set with a total number of 9830 candidates.

Testing Data Patient and Polyp Info: There were 67 patients with 133 volumes. A total of 53 polyps were identified in this set with a total number of 6616 candidates. A combined total of 207 features are extracted for each candidate by three imaging scientists.

Feature Selection and Classification: In this experiment three feature selection methods where considered in a wrapper framework and compare their prediction performance on the Colon Dataset. These techniques are namely, the sparse formulation proposed in this study (SFLD), the sparse formulation for Kernel Fisher Discriminant with linear loss and linear regularizer (SKFD) and a greedy sequential forward-backward feature selection algorithm implemented with FLD (GFLD).

Sparse Fisher Linear Discriminant (SFLD): The choice of plays an important role on the generalization performance of a method according to an embodiment of the present disclosure. It regularizes the FLD by seeking a balance between the “goodness of fit”, e.g., Rayleigh Quotient and the number of features used to achieve this performance.

The value of this parameter is estimated by cross validation. Leave-One-Patient-Out (LOPO) cross validation may be implemented. In this scheme, both views are left out, e.g., the supine and the prone views, of one patient from the training data. The classifier is trained using the patients from the remaining set, and tested on both views of the “left-out” patient. LOPO is superior to other cross-validation metrics such as leave-one-volume-out, leave-one-polyp-out or k-fold cross-validation because it simulates the actual use, wherein the CAD system processes both volumes for a new patient. For instance, with any of the above alternative methods, if a polyp is visible in both views, the corresponding candidates could be assigned to different folds; thus a classifier may be trained and tested on the same polyp (albeit in different views).

To find the optimum value of γ, a method is run for varying sizes of γε [1d]. For each value of the Receiver Operating Characteristics (ROC) curve is obtained by evaluating the Leave One Patient Out (LOPO) Cross Validation performance of a sparse FLD method and determining the area under this curve. The optimum value of γ is chosen as the value that results in the largest area.

Kernel Fisher Discriminant with linear loss and linear regularizer (SKFD): In this approach there is a set of constraints for every data point on the training set which leads to large optimization problems. To alleviate the computational burden on mathematical programming formulation for this approach Laplacian models may be implemented for both the loss function and the regularizer. This choice leads to linear programming formulation instead of the quadratic programming formulation that is obtained when a Gaussian model is assumed for both the loss function and the regularizer.

The linear programming formulation used is written as:

$$\begin{matrix}{min}_{( α , β , ∈ ) ∈ {R}^{n + 1 + m}} & v {‖ ∈ ‖}_{1} + {‖ α ‖}_{1} \\ s . t . & \begin{matrix}A α + β = y + ∈ \\ {ⅇ}_{i}^{′} {∈}_{i} = 0 for i ∈ \{ + \} \\ {ⅇ}_{i}^{′} {∈}_{i} = 0 for i ∈ \{ - \}\end{matrix}\end{matrix} \qquad ( 4 )$$

where e± is vector of ones of size the number of points in class ±. The final classifier for an unseen data point x is given by sign (α^{T}x−β). The regularization parameter is estimated by LOPO.

Greedy sequential forward-backward feature selection algorithm with FLD (GFLD): This approach starts with an empty subset and performs a forward selection succeeded by a backward attempt to eliminate a feature from the subset. During each iteration of the forward selection exactly one feature is added to the feature subset. To determine which feature to add, the algorithm tentatively adds to the candidate feature subset one feature that is not already selected and tests the LOPO performance of a classifier built on the tentative feature subset. The feature that results in the largest area under the ROC curve is added to the feature subset. During each iteration of the backward elimination the algorithm attempts to eliminate the feature that results in the largest ROC area gain. This process goes on until no or negligible improvement is gained. In this study the algorithm stops when the increase on the ROC area after a forward selection is less than 0.005. A total of 17 features is selected before this constraint is met.

SKFD was run on a subset of the training dataset where all the positive candidates and a random subset of size 1000 of the negative candidates where included. The 5 algorithms run included:

1. SFLD on the original training set.

2. GFLD on the original training set.

3. Conventional on the original training set.

4. SKFD on the subset training set.

5. SFLK on the subset training set (denoted as SFLDsub).

Table 1: The number of features selected (d), the area of the ROC curve scaled by 100 (Area) and the sensitivity corresponding to 90% specificity (Sens) is shown for all algorithms considered in this study. The values in parenthesis show the corresponding values for the testing results.

TABLE 1

| Algorithm | d | Area | Sens (%) |
|---|---|---|---|
| SFLD | 25 | 94.8 (94.9) | 89 (87) |
| SFLD-sub | 17 | 94.7 (94.1) | 92 (85) |
| GFLD | 17 | 94.3 (94.7) | 85 (83) |
| SKFD | 18 | 88.0 (82.0) | 65 (60) |
| FLD | 207 | 80.3 (89.1) | 63 (77) |

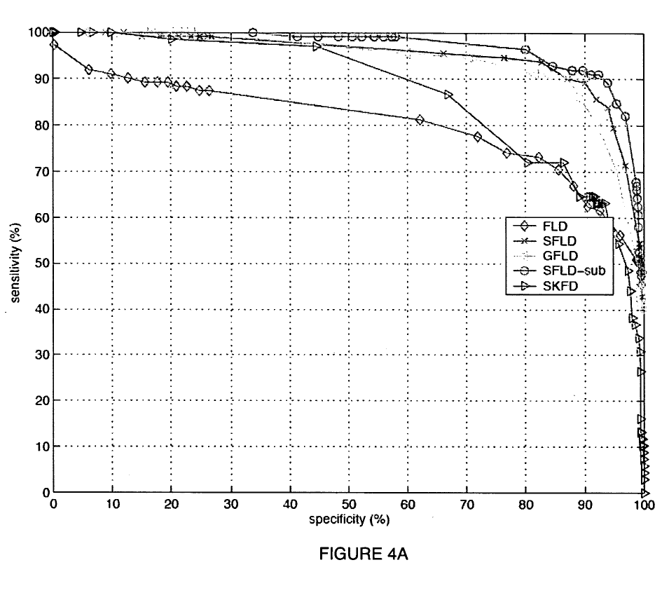

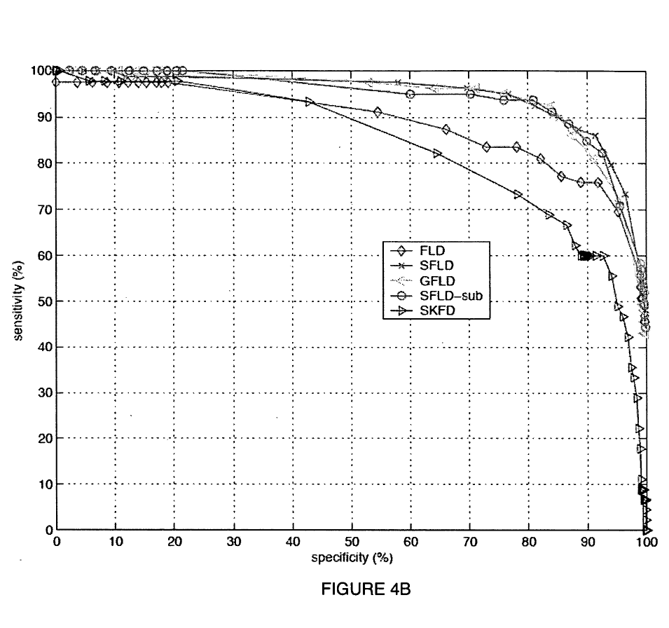

The ROC curves in FIG. 3 demonstrates the LOPO performance of the each method and those in FIG. 4 show the performance on the test data set. Table 1 shows the number of features selected (d), the area of the ROC curve scaled by 100 (Area) and the sensitivity corresponding to 90% specificity (Sens) for all algorithms considered in this study.

These results show that Sparse (SFLD) and SFLDsub outperform the greedy and conventional FLD and SKFD both on the training and testing datasets. Although SFLD-sub performs better than SFLD on the training data, SFLD generalizes slightly better on the testing data. This is not surprising because SFLD-sub uses a subset of the original training data. GFLD performs almost equally well with SFLDsub and SFLD methods but the difference is hidden in the computational cost needed to select the features in GFLD. The computational cost of GFLD is proportional to d³ whereas that of SFLD is proportional to d².

According to an embodiment of the present disclosure, a method for sparse formulation of the Fisher Linear Discriminant is applied to medical images. The method is applicable to other images. Experimental results favor the proposed algorithm over two other feature selection/regularization techniques implemented in the FLD framework both in terms of prediction accuracy and the computational cost fir large data sets.

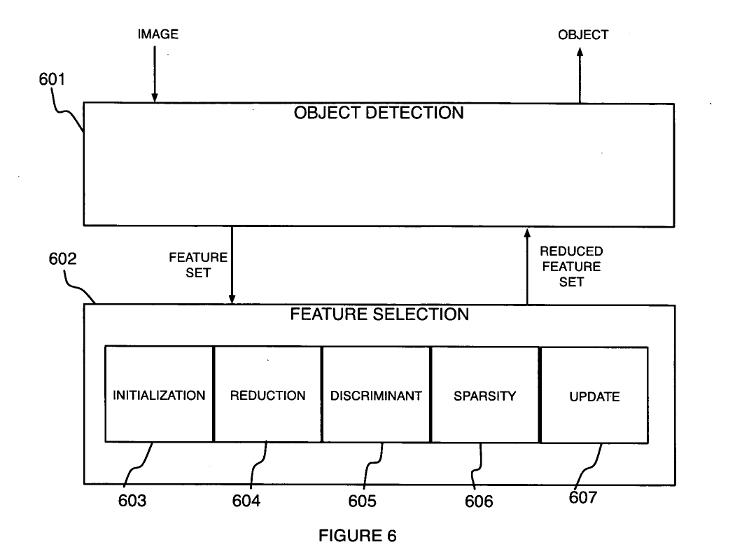

Referring to FIG. 6, a computer-implemented detection system includes an object detection module determining a candidate object and a feature set for the candidate object 601. The system includes a feature selection module 602 coupled to the object detection module 601, wherein the feature selection module 602 receives the feature set and generates a reduced feature set having a desirable value of a Rayleigh quotient, wherein the object detection modules 601 implements the reduced feature set for detecting an object in an image.

A feature selection module includes an initialization module 603 setting an initial value of a discriminant vector and a regularization parameter, a reduction module 604 determining the reduced feature set according to the discriminant vector, wherein features of the feature set with an element of the discriminant vector greater than a threshold are selected as the reduced feature set, a discriminant module 605 determining a class scatter matrix and mean in a reduced dimensional space defined by the reduced feature set, a sparsity module 606 determining a transformation vector, and an update module 607 updating the class scatter matrix and means according to the transformation vector, wherein the sparsity module 606 determines the discriminant vector given the updated class scatter matrix and means.

Having described embodiments for a system and method for feature selection in an object detection system, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

1. A computer-implemented method for processing an image comprising:
identifying a plurality of candidates for an object of interest in the image;
extracting a feature set for each candidate;
determining a reduced feature set by removing a least one redundant feature from the feature set to maximize a Rayleigh quotient;
determining at least one candidate of the plurality of candidates as a positive candidate based on the reduced feature set; and
displaying the positive candidate for analysis of the object.

2. The computer-implemented method of claim 1, wherein determining the reduced feature set comprises:
initializing a discriminant vector and a regularization parameter; and
determining, iteratively, the reduced feature set.

3. The computer-implemented method of claim 2, wherein determining, iteratively, the reduced feature set comprises:
determining the reduced feature set according to the discriminant vector, wherein features of the feature set with an element of the discriminant vector greater than a threshold are selected as the reduced feature set;
determining a class scatter matrix and mean in a reduced dimensional space defined by the reduced feature set;
determining a transformation vector;
updating the class scatter matrix and means according to the transformation vector; and
determining the discriminant vector.

4. The computer-implemented method of claim 2, further comprising:
comparing, at each iteration, each element of the discriminant vector to a threshold; and
stopping the iterative determination of the reduced feature set upon determining that all elements are greater than the threshold.

5. The computer-implemented method of claim 4, wherein the threshold is a user defined variable for controlling a degree to which features are eliminated.

6. The computer-implemented method of claim 2, wherein the transformation vector and the discriminant vector can be determined as:
$$\begin{matrix}{min}_{α , a ∈ {R}^{d}} & {α}^{T} ( {S}_{w} * ( {aa}^{T} ) ) α \\ s . t . & {α}^{T} ( ( {m}_{+} - {m}_{-} ) * a = b \\ & {α}^{T} {e}_{l} \leq γ , α \geq 0\end{matrix} .$$

7. A program storage device readable by machine, tangibly embodying a program of instructions executable by the machine to perform method steps for processing an image, the method steps comprising:
identifying a plurality of candidates for an object of interest in the image;
extracting a feature set for each candidate;
determining a reduced feature set by removing a least one redundant feature from the feature set to maximize a Rayleigh quotient;
determining at least one candidate of the plurality of candidates as a positive candidate based on the reduced feature set; and
displaying the positive candidate for analysis of the object.

8. The method of claim 7, wherein determining the reduced feature set comprises:
initializing a discriminant vector and a regularization parameter; and
determining, iteratively, the reduced feature set.

9. The method of claim 8, wherein determining, iteratively, the reduced feature set comprises:
determining the reduced feature set according to the discriminant vector, wherein features of the feature set with an element of the discriminant vector greater than a threshold are selected as the reduced feature set;
determining a class scatter matrix and mean in a reduced dimensional space defined by the reduced feature set;
determining a transformation vector;
updating the class scatter matrix and means according to the transformation vector; and
determining the discriminant vector.

10. The method of claim 8, further comprising:
comparing, at each iteration, each element of the discriminant vector to a threshold; and
stopping the iterative determination of the reduced feature set upon determining that all elements are greater than the threshold.

11. The method of claim 10, wherein the threshold is a user defined variable for controlling a degree to which features are eliminated.

12. The method of claim 8, wherein the transformation vector and the discriminant vector can be determined as:
$$\begin{matrix}{min}_{α , a ∈ {R}^{d}} & {α}^{T} ( {S}_{w} * ( {aa}^{T} ) ) α \\ s . t . & {α}^{T} ( ( {m}_{+} - {m}_{-} ) * a = b \\ & {α}^{T} {e}_{l} \leq γ , α \geq 0\end{matrix} .$$

13. A computer-implemented detection system comprising:
an object detection module determining a candidate object and a feature set for the candidate object; and
a feature selection module coupled to the object detection module, wherein the feature selection module receives the feature set and generates a reduced feature set having a desirable value of a Rayleigh quotient, wherein the object detection modules implements the reduced feature set for detecting an object in an image.

14. The computer-implemented detection system of claim 13, wherein the feature selection module further comprises:
an initialization module setting an initial value of a discriminant vector and a regularization parameter;
a reduction module determining the reduced feature set according to the discriminant vector, wherein features of the feature set with an element of the discriminant vector greater than a threshold are selected as the reduced feature set;
a discriminant module determining a class scatter matrix and mean in a reduced dimensional space defined by the reduced feature set;
a sparsity module determining a transformation vector; and
an update module updating the class scatter matrix and means according to the transformation vector, wherein the sparsity module determines the discriminant vector given the updated class scatter matrix and means.
